(19) United States
(12) Patent Application Publication
(10) Pub. No.: US 2004/0103248 A1
(43) Pub. Date: May 27, 2004

(54) Advanced telecommunications processor

(76) Inventors: David T. Hass, Santa Clara, CA (US); Nazar A. Zaidi, San Jose, CA (US); Abbas Rashid, Fremont, CA (US)

Correspondence Address: IPSG, P.C., P.O. BOX 700640, SAN JOSE, CA, 95170-0640, US

(21) Appl. No.: 10/682,579

(22) Filed: Oct. 8, 2003

Related U.S. Application Data
(60) Provisional application No. 60/490,236, filed on Jul. 25, 2003.
(60) Provisional application No. 60/416,838, filed on Oct. 8, 2002.

(51) Int. Cl. G06F 12/00

(52) U.S. Cl. 711/117

(57) ABSTRACT

An advanced telecommunications processor comprises a plurality of multithreaded processor cores each having a data cache and instruction cache. A data switch interconnect is coupled to each of the processor cores and configured to pass information among the processor cores. A messaging network is coupled to each of the processor cores and a plurality of communication ports. In one aspect of the invention, the data switch interconnect is coupled to each of the processor cores by its respective data cache, and the messaging network is coupled to each of the processor cores by its respective instruction cache. Advantages of the invention include the ability to provide high bandwidth communications between computer systems and memory in an efficient and cost-effective manner.

### RELATED APPLICATIONS

This application claims priority to Prov. No. 60/490,236 filed Jul. 25, 2003 (RZMI-P101P2) and Prov. No. 60/416,838 filed Oct. 8, 2002 (RZMI-P101P1), incorporated herein by reference.

### FIELD

The invention relates to the field of telecommunications, and more particularly to an advanced telecommunications processor.

### BACKGROUND

Modern telecommunications systems provide great benefits including the ability to communicate information around the world. Conventional architectures for telecommunications equipment include a large number of discrete circuits, which causes inefficiencies in both the processing capabilities and the communication speed. FIG. 1 depicts such a conventional line card employing a number of discrete chips and technologies.

Advances in processors and other components have improved the ability of telecommunications equipment to process, manipulate, store, retrieve and deliver information. Recently, engineers have begun to combine functions into integrated circuits to reduce the overall number of discrete integrated circuits, while still performing the required functions at equal or better levels of performance. This combination has been spurred from the ability to increase the number of transistors on a chip with new technology and the desire to reduce costs. Some of these combined integrated circuits have become so highly functional that they are often referred to as a system on a chip (SoC). However, combining circuits and systems on a chip can become very complex and pose a number of engineering challenges. For example, hardware engineers want to ensure flexibility for future designs and software engineers who want to ensure that their software will run on the chip.

The demand for sophisticated new networking and communications applications continues to grow in advanced switching and routing. In addition, solutions such as content-aware networking, highly integrated security, and new forms of storage management are beginning to migrate into flexible multi-service systems. Enabling technologies for these and other next generation solutions must provide intelligence and high performance with the flexibility for rapid adaptation to new protocols and services.

Consequently, what is needed is an advanced processor that can take advantage of the new technologies while also providing high performance functionality with flexible modification ability.

### SUMMARY

The present invention provides useful novel structures and techniques for overcoming the identified limitations, and provides an advanced processor that can take advantage of new technologies while also providing high performance functionality with flexible modification ability. The invention employs an advanced architecture system on a chip (SoC) including modular components and communication structures to provide a high performance device.

An advanced telecommunications processor comprises a plurality of multithreaded processor cores each having a data cache and instruction cache. A data switch interconnect is coupled to each of the processor cores and configured to pass information among the processor cores. A messaging network is coupled to each of the processor cores and a plurality of communication ports.

In one aspect of the invention, the data switch interconnect is coupled to each of the processor cores by its respective data cache, and the messaging network is coupled to each of the processor cores by its respective instruction cache.

In one aspect of the invention, the advanced telecommunications processor further comprises a level 2 cache coupled to the data switch interconnect and configured to store information accessible to the processor cores.

In one aspect of the invention, the advanced telecommunications processor further comprises an interface switch interconnect coupled to the messaging network and the plurality of communication ports and configured to pass information among the messaging network and the communication ports.

In one aspect of the invention, the advanced telecommunications processor further comprises a memory bridge coupled to the data switch interconnect and at least one communication port, and is configured to communicate with the data switch interconnect and the communication port.

In one aspect of the invention, the advanced telecommunications processor further comprises a super memory bridge coupled to the data switch interconnect, the interface switch interconnect and at least one communication port, and is configured to communicate with the data switch interconnect, the interface switch interconnect and the communication port.

Advantages of the invention include the ability to provide high bandwidth communications between computer systems and memory in an efficient and cost-effective manner.

### BRIEF DESCRIPTION OF THE FIGURES

The invention is described with reference to the Figures, in which:

FIG. 1 depicts a line card according to the prior art; and

FIG. 2 depicts an exemplary advanced processor according to an embodiment of the invention.

### DETAILED DESCRIPTION

The invention is described with reference to specific architectures and protocols. Those skilled in the art will recognize that the description is for illustration and to provide the best mode of practicing the invention. The description is not meant to be limiting. For example, reference is made to Ethernet Protocol, Internet Protocol, Hyper Transport Protocol and other protocols, but the invention may be applicable to other protocols as well. Moreover, reference is made to chips that contain integrated circuits while other hybrid or meta-circuits combining those described in chip form is anticipated.

### A. Architecture Overview

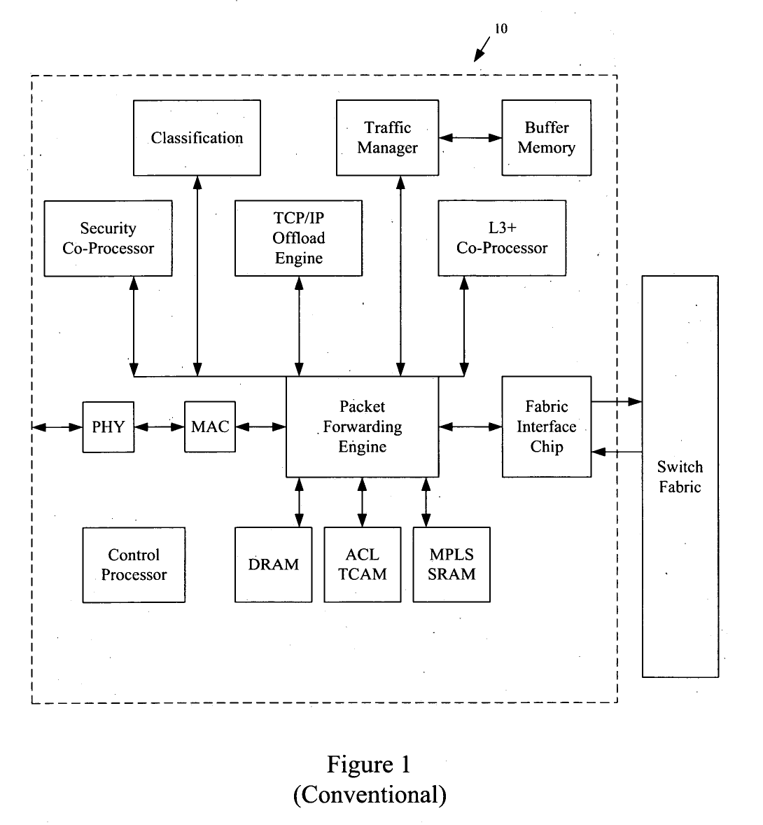

The invention is designed to consolidate a number of the functions performed on the prior art line card of FIG. 1, and to enhance the line card functionality. In one embodiment, the invention is an integrated circuit that includes circuitry for performing many discrete functions. The integrated circuit design is tailored for communication processing. Accordingly, the processor design emphasizes memory intensive operations rather than computationally intensive operations. The processor design includes an internal network configured for high efficient memory access and threaded processing as described below.

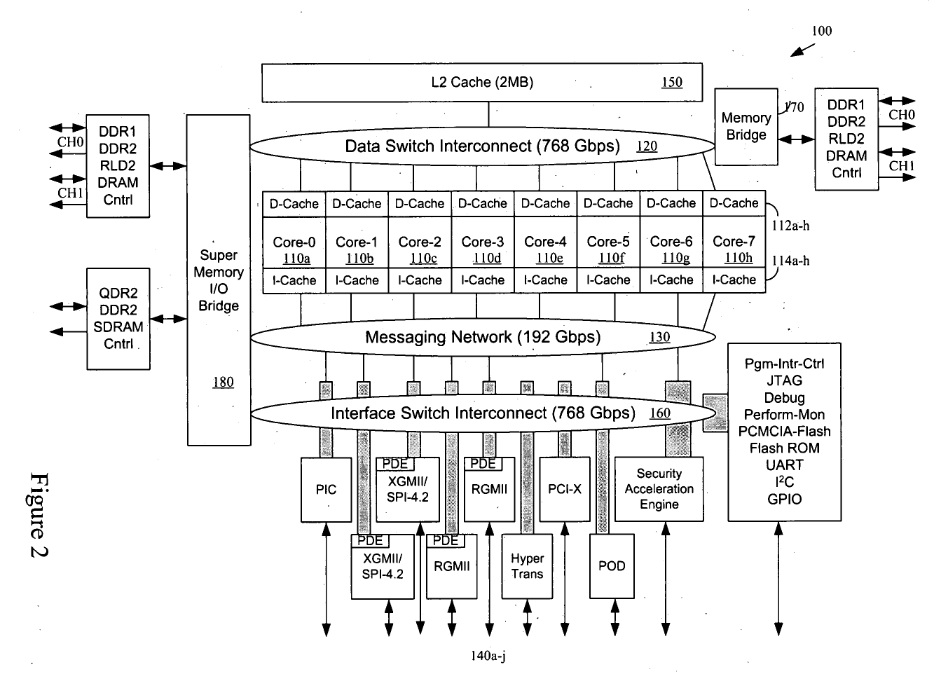

FIG. 2 depicts an exemplary advanced processor according to an embodiment of the invention. The advanced processor is an integrated circuit that can perform many of the functions previously tasked to specific integrated circuits. For example, the advanced processor includes a packet forwarding engine, a level 3 co-processor and a control processor. The processor can include other components, as desired. As shown herein, given the number of exemplary functional components, the power dissipation is approximately 20 watts.

### B. Processor Architecture and Design

The exemplary processor is designed as a network on a chip. This distributed processing architecture allows components to communication with one another and not necessarily share a common clock rate. For example, one processor component could be clocked at a high rate while another processor component is clocked at a low rate. The network architecture further supports the ability to add other components in future designs by simply adding the component to the network. For example, if a future communication interface is desired, that interface can be laid out on the processor chip and coupled to the processor network. Then, future processors can be fabricated with the new communication interface.

The advanced processor comprises a plurality of multithreaded processor cores 110a-h each having a data cache 112a-h and instruction cache 114a-h respectively. A data switch interconnect 120 is coupled to each of the processor cores and configured to pass information among the processor cores. A messaging network 130 is coupled to each of the processor cores 110a-h and a plurality of communication ports 140a-j.

The processor includes multiple CPU cores capable of multi-threaded operation. In the exemplary embodiment, there are eight 4-way multi-threaded MIPS64-compatible CPUs, which are often referred to as processor cores. The invention includes 32 hardware contexts and the CPU cores will operate at over 1.5 GHz. One aspect of the invention is the redundancy and fault tolerant nature of multiple CPU cores so, for example, if one of the cores stopped functioning, the other cores would continue operation and the system would experience only slightly degraded overall performance. In one embodiment, a ninth processor core is added to the architecture to ensure with a high degree of certainty that eight cores are functional.

The exemplary processor further includes a number of components that promote high performance, including: a 4-way set associative on-chip L2 cache (2 MB); a cache coherent Hyper Transport interface (768 Gbps); hardware accelerated QOS and classification; security hardware acceleration—AES, 3DES, RSA, SHA/MD5; packet ordering support; string processing support; TOE hardware (TCP Offload Engine); and 800 IO signals.

In one aspect of the invention, the data switch interconnect 120 is coupled to each of the processor cores 110a-h by its respective data cache 112a-h, and the messaging network 130 is coupled to each of the processor cores 110a-h by its respective instruction cache 114a-h.

In one aspect of the invention, the advanced telecommunications processor further comprises a level 2 cache 150 coupled to the data switch interconnect and configured to store information accessible to the processor cores 110a-h.

In one aspect of the invention, the advanced telecommunications processor further comprises an interface switch interconnect 160 coupled to the messaging network 130 and the plurality of communication ports 140a-j and configured to pass information among the messaging network 130 and the communication ports 140a-j.

In one aspect of the invention, the advanced telecommunications processor further comprises a memory bridge 170 coupled to the data switch interconnect and at least one communication port, and configured to communicate with the data switch interconnect and the communication port.

In one aspect of the invention, the advanced telecommunications processor further comprises a super memory bridge 180 coupled to the data switch interconnect, the interface switch interconnect and at least one communication port, and configured to communicate with the data switch interconnect, the interface switch interconnect and the communication port.

### B. Design Goals

### 1. Design Philosophy

The design philosophy is to create a processor that can be programmed using general purpose software tools and reusable components. Several features that support this design philosophy include: static gate design; low-risk custom memory design; flip flop based design; design for testability including a full scan, memory built in self-test (BIST), architecture redundancy and tester support features; reduced power consumption including clock gating, logic gating and memory banking; datapath and control separation including intelligently guided placement; and rapid feedback of physical implementation.

### 2. Software Philosophy

The software philosophy is to enable utilization of industry standard development tools and environment. The desire is to program the processing using general purpose software tools and reusable components. The industry standard tools and environment include familiar tools, such as gcc/gdb and the ability to develop in an environment chosen by the customer or programmer.

The desire is also to protect existing and future code investment by providing a hardware abstraction layer (HAL) definition. This enables easy porting of existing applications and code compatibility with future chip generations.

### 3. CPU Architecture

Turning to the CPU core, the core is designed to be MIPS64 compliant and have a frequency target in the range of 1.5 GHz+. Additional features supporting the architecture include: 4-way multithreaded single issue 7-stage pipeline; real time processing support including cache line locking and vectored interrupt support; 32 KB 4-way set associative instruction cache; 32 KB 4-way set associative data cache; and 128-entry TLB.

### 4. Processor I/O

One of the important aspects of the invention is the high-speed processor input/output (I/O), which is supported by: 2 XGMII/SPI-4; 3 1Gb MACs; 1 16-bit HyperTransport that can scale to 800/1600 Mhz memory including 1 flash portion and 2 QDR2/DDR2 SRAM portions; 2 64-bit DDR2 channels that can scales to 400/800 Mhz; and communication ports including 32-bit PCI, JTAG and UART.

### 5. CPU Architecture Philosophy

The architecture philosophy for the CPU is to optimize for thread level parallelism (TLP) rather than instruction level parallelism (ILP) including networking workloads benefit from TLP architectures, and keeping it small.

The architecture allows for many CPU instantiations on a single chip, which in turn supports scalability. In general, super-scalar designs have minimal performance gains on memory bound problems. An aggressive branch prediction is typically unnecessary for this type of processor application and can even be wasteful.

The invention employs narrow pipelines because they typically have much better frequency scalability. Consequently, memory latency is not as much of an issue as it would be in other types of processors, and in fact, any memory latencies can effectively be hidden by the multithreading as described below.

The invention optimizes the memory subsystem with non-blocking loads, memory reordering at the CPU interface, and special instruction for semaphores and memory barriers.

In one aspect of the invention, the processor acquires and releases semantics added to load/stores. In another aspect of the invention, the processor employs special atomic increment for timer support.

### 6. Multithreading

As described above, the multithreaded CPUs offer benefits over conventional techniques. An exemplary embodiment of the invention employs fine grained multithreading that switches threads every clock and has 4 threads available for issue.

The multithreading aspect provides for the following: use empty cycles caused by long latency operations; optimized for area vs. performance trade-off; ideal for memory bound applications; enable optimal utilization of memory bandwidth; memory subsystem; cache coherency using MOESI protocol; full map cache directory including reduced snoop bandwidth and increased scalability over broadcast snoop approach; large on chip shared dual banked 2 MB L2 cache; ECC protected caches and memory; 2 64-bit 400/800 DDR2 channels—12.8 GByte/s peak bandwidth—security Pipeline; supports on-chip standard security functions -AES/3DES/SHA/MD5/RSA; allows chaining of functions—e.g. encrypt→sign—reduces Memory Accesses; 4 Gbs of bandwidth per security pipeline—not including RSA;o

n-chip switch interconnect; message passing mechanism for intra-chip communication; point to point connection between super-blocks—increased scalability over shared bus approach; 16 byte full duplex links for data messaging—32 GB/s of bandwidth per link at 1 GHz; and credit based flow control mechanism.

Some of the benefits of the multithreading technique used with the multiple processor cores include memory latency tolerance and fault tolerance.

### C. Conclusion

Advantages of the invention include the ability to provide high bandwidth communications between computer systems and memory in an efficient and cost-effective manner.

Having disclosed exemplary embodiments and the best mode, modifications and variations may be made to the disclosed embodiments while remaining within the subject and spirit of the invention as defined by the following claims.

1. An advanced telecommunications processor, comprising:
a plurality of multithreaded processor cores each having a data cache and instruction cache;
a data switch interconnect coupled to each of the processor cores and configured to pass information among the processor cores; and
a messaging network coupled to each of the processor cores and a plurality of communication ports.

2. The advanced telecommunications processor of claim 1, further comprising:
the data switch interconnect is coupled to each of the processor cores by its respective data cache; and
the messaging network is coupled to each of the processor cores by its respective instruction cache.

3. The advanced telecommunications processor of claim 1, further comprising:
a level 2 cache coupled to the data switch interconnect and configured to store information accessible to the processor cores.

4. The advanced telecommunications processor of claim 2, further comprising:
a level 2 cache coupled to the data switch interconnect and configured to store information accessible to the processor cores.

5. The advanced telecommunications processor of claim 1, further comprising:
an interface switch interconnect coupled to the messaging network and the plurality of communication ports and configured to pass information among the messaging network and the communication ports.

6. The advanced telecommunications processor of claim 2, further comprising:
an interface switch interconnect coupled to the messaging network and the plurality of communication ports and configured to pass information among the messaging network and the communication ports.

7. The advanced telecommunications processor of claim 3, further comprising:
an interface switch interconnect coupled to the messaging network and the plurality of communication ports and configured to pass information among the messaging network and the communication ports.

8. The advanced telecommunications processor of claim 4, further comprising:
an interface switch interconnect coupled to the messaging network and the plurality of communication ports and configured to pass information among the messaging network and the communication ports.

9. The advanced telecommunications processor of claim 1, further comprising:
a memory bridge coupled to the data switch interconnect and at least one communication port, and configured to communicate with the data switch interconnect and the communication port.

10. The advanced telecommunications processor of claim 2, further comprising:
a memory bridge coupled to the data switch interconnect and at least one communication port, and configured to communicate with the data switch interconnect and the communication port.

11. The advanced telecommunications processor of claim 3, further comprising:
a memory bridge coupled to the data switch interconnect and at least one communication port, and configured to communicate with the data switch interconnect and the communication port.

12. The advanced telecommunications processor of claim 4, further comprising:
a memory bridge coupled to the data switch interconnect and at least one communication port, and configured to communicate with the data switch interconnect and the communication port.

13. The advanced telecommunications processor of claim 5, further comprising:
a memory bridge coupled to the data switch interconnect and at least one communication port, and configured to communicate with the data switch interconnect and the communication port.

14. The advanced telecommunications processor of claim 6, further comprising:
a memory bridge coupled to the data switch interconnect and at least one communication port, and configured to communicate with the data switch interconnect and the communication port.

15. The advanced telecommunications processor of claim 7, further comprising:
a memory bridge coupled to the data switch interconnect and at least one communication port, and configured to communicate with the data switch interconnect and the communication port.

16. The advanced telecommunications processor of claim 8, further comprising:
a memory bridge coupled to the data switch interconnect and at least one communication port, and configured to communicate with the data switch interconnect and the communication port.

17. The advanced telecommunications processor of claim 1, further comprising:
a super memory bridge coupled to the data switch interconnect, the interface switch interconnect and at least one communication port, and configured to communicate with the data switch interconnect, the interface switch interconnect and the communication port.

18. The advanced telecommunications processor of claim 2, further comprising:
a super memory bridge coupled to the data switch interconnect, the interface switch interconnect and at least one communication port, and configured to communicate with the data switch interconnect, the interface switch interconnect and the communication port.

19. The advanced telecommunications processor of claim 3, further comprising:
a super memory bridge coupled to the data switch interconnect, the interface switch interconnect and at least one communication port, and configured to communicate with the data switch interconnect, the interface switch interconnect and the communication port.

20. The advanced telecommunications processor of claim 4, further comprising:
a super memory bridge coupled to the data switch interconnect, the interface switch interconnect and at least one communication port, and configured to communicate with the data switch interconnect, the interface switch interconnect and the communication port.

21. The advanced telecommunications processor of claim 5, further comprising:
a super memory bridge coupled to the data switch interconnect, the interface switch interconnect and at least one communication port, and configured to communicate with the data switch interconnect, the interface switch interconnect and the communication port.

22. The advanced telecommunications processor of claim 6, further comprising:
a super memory bridge coupled to the data switch interconnect, the interface switch interconnect and at least one communication port, and configured to communicate with the data switch interconnect, the interface switch interconnect and the communication port.

23. The advanced telecommunications processor of claim 7, further comprising:
a super memory bridge coupled to the data switch interconnect, the interface switch interconnect and at least one communication port, and configured to communicate with the data switch interconnect, the interface switch interconnect and the communication port.

24. The advanced telecommunications processor of claim 8, further comprising:
a super memory bridge coupled to the data switch interconnect, the interface switch interconnect and at least one communication port, and configured to communicate with the data switch interconnect, the interface switch interconnect and the communication port.

25. The advanced telecommunications processor of claim 9, further comprising:
a super memory bridge coupled to the data switch interconnect, the interface switch interconnect and at least one communication port, and configured to communicate with the data switch interconnect, the interface switch interconnect and the communication port.

26. The advanced telecommunications processor of claim 10, further comprising:
a super memory bridge coupled to the data switch interconnect, the interface switch interconnect and at least one communication port, and configured to communicate with the data switch interconnect, the interface switch interconnect and the communication port.

27. The advanced telecommunications processor of claim 11, further comprising:.
a super memory bridge coupled to the data switch interconnect, the interface switch interconnect and at least one communication port, and configured to communicate with the data switch interconnect, the interface switch interconnect and the communication port.

28. The advanced telecommunications processor of claim 12, further comprising:
a super memory bridge coupled to the data switch interconnect, the interface switch interconnect and at least one communication port, and configured to communicate with the data switch interconnect, the interface switch interconnect and the communication port.

29. The advanced telecommunications processor of claim 13, further comprising:
a super memory bridge coupled to the data switch interconnect, the interface switch interconnect and at least one communication port, and configured to communicate with the data switch interconnect, the interface switch interconnect and the communication port.

30. The advanced telecommunications processor of claim 14, further comprising:
a super memory bridge coupled to the data switch interconnect, the interface switch interconnect and at least one communication port, and configured to communicate with the data switch interconnect, the interface switch interconnect and the communication port.

31. The advanced telecommunications processor of claim 15, further comprising:
a super memory bridge coupled to the data switch interconnect, the interface switch interconnect and at least one communication port, and configured to communicate with the data switch interconnect, the interface switch interconnect and the communication port.

32. The advanced telecommunications processor of claim 16, further comprising:
a super memory bridge coupled to the data switch interconnect, the interface switch interconnect and at least one communication port, and configured to communicate with the data switch interconnect, the interface switch interconnect and the communication port.
